(19) United States
(12) Patent Application Publication
(10) Pub. No.: US 2001/0034616 A1
(43) Pub. Date: Oct. 25, 2001

(54) Billing process for botanicals, supplements and homeopathic remedies

(76) Inventor: Jo Melinna Giannini, Las Cruces, NM (US)

Correspondence Address: Richard C. Litman, LITMAN LAW OFFICES, LTD., P.O. Box 15035, Arlington, VA, 22215, US

(21) Appl. No.: 09/838,450

(22) Filed: Apr. 20, 2001

Related U.S. Application Data
(60) Provisional application No. 60/198,757, filed on Apr. 21, 2000.

(51) Int. Cl. G06F 17/60

(52) U.S. Cl. 705/2

(57) ABSTRACT

A business method for billing customers for alternative botanical, supplemental and homeopathic remedies by electronically creating unique codes for these remedies and an electronic connection to the universal product codes and the national drug codes.

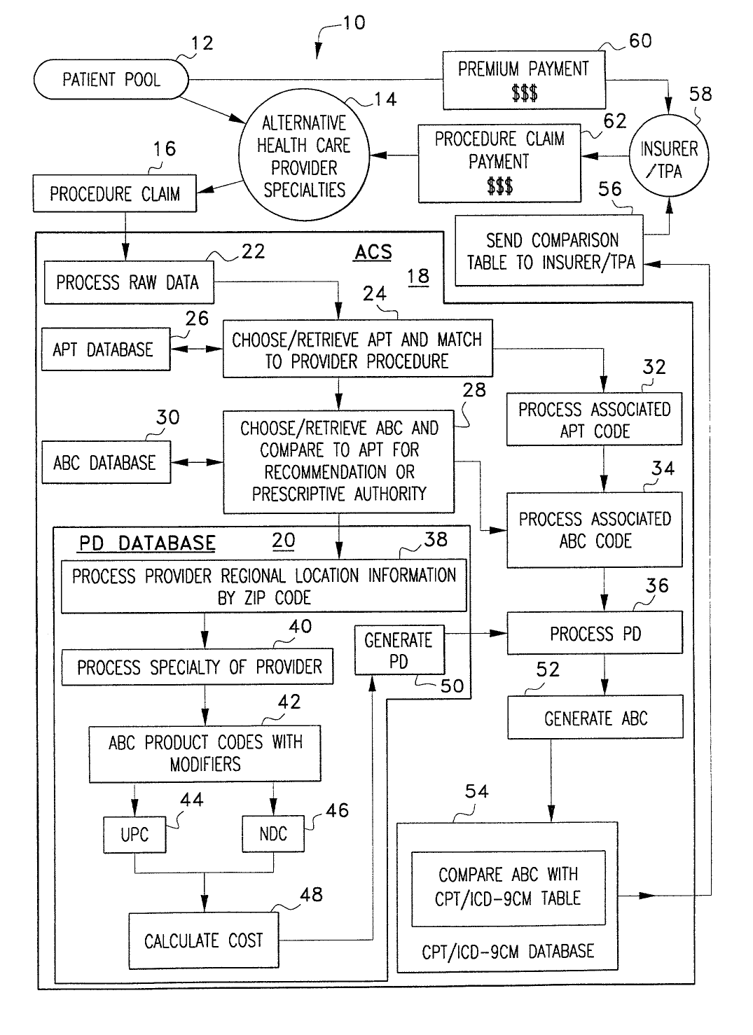

### CROSS-REFERENCE TO RELATED APPLICATION

This application claims the benefit of U.S. Provisional Patent Application Serial No. 60/198,757, filed Apr. 21, 2000.

### BACKGROUND OF THE INVENTION

1. Field of the Invention

The present invention relates generally to information and billing for nutraceuticles. More specifically, the invention is a business method for billing customers for alternative remedies such as botanicals, supplements and homeopathic remedies, and electronically creates unique codes for these remedies and an electronic connection to the universal product codes and the national drug codes to track the efficacy of these products when used to treat patients for specific health items.

2. Description of Related Art

The relevant art of interest describes various business methods concerning the billing process, but none discloses the present method. There is a need for connecting the Universal Product Code (UPC) and the National Drug Code (NDC) to couple the dosage, the number of units, and the like information of a product to the patient encounter as expressed in electronically coded claims and paper claim forms. In addition, the pairing of these codes would automatically connect a product to the diagnosis of a patient, capture data for assessing the patient's outcome, allow the product to be billed as part of the treatment, and would tie to the legal references within the context of the state laws governing the providers able to prescribe, recommend or distribute these products.

The relevant art will be discussed in the order of perceived relevance to the present invention.

U.S. Pat. No. 5,915,241 issued on Jun. 22, 1999, to Jo M. Giannini describes a method and system for encoding and processing alternative healthcare provider billing processes comprising a computer assisted network for encoding, documenting and processing claims for payment of specific procedures by alternative therapy providers, grouped geographically and by specialty. The system accesses three main databases, the Alternative Practice Table (APT), the Standard Alternative Procedure Description (SAPD) and the Provider Data (PD) to produce an Alternative Billing Code (ABC) which can be compared and correlated with insurance industry standard codes. The method is distinguishable for failing to develop product codes for nutraceuticals that utilize the Universal Product Codes and the National Drug Codes.

U.S. Pat. No. 5,644,778 issued on Jul. 1, 1997, to James L. Burks et al. describes a medical transaction system allowing a plurality of healthcare providers to interact with a plurality of payers and financial institutions. The healthcare providers, payers and financial institutions are not required to communicate in the same data message formats or communication protocols. The system supports the processing of medical claims without requiring a centralized database or imposing a uniform claim format on the healthcare providers and payers. The system is distinguishable for its lack of a centralized database and a uniform claim format.

U.S. Pat. No. 5,845,255 issued on Dec. 1, 1998, to Christian Mayaud describes a wireless, deployable, electronic prescription management system for physician use comprising the capturing of patient condition-objective of the prescribed treatment into a prescription and provides for patient record assembly from source elements with privacy controls, adverse indication review and on-line access to drug information and scientific literature. The system is distinguishable for its manifold prescription information and on-line Internet information retrieval.

U.S. Pat. No. 5,950,173 issued on Sep. 7, 1999, to Thomas J. Perkowski describes a system and method for finding and serving consumer product-related information over the Internet to consumers in retail shopping environments, home, work, and on the road. A Universal Product Code is preassigned to each consumer product along with a list of Uniform Resource Locators that point to the location of the information on the Internet. The system is distinguishable for its Internet-based consumer product-related information.

The following relevant prior art patents pertain to medical information systems.

U.S. Pat. No. 5,930,759 issued on Jul. 27, 1999, to James G. Moore et al. describes a system or network for assembling, filing and processing health care data transaction and insurance claims made by patients pursuant to health care policies issued to the patients by insurance companies or other carriers for service provided to the patients at health care facilities.

U.S. Pat. No. 5,924,074 issued on Jul. 13, 1999, to Jae A. Evans describes a medical records system that captures patient data such as patient complaints, lab orders, medications, diagnoses, and procedures, at its source at the time of entry using a graphical user interface having touch screens.

U.S. Pat. No. 5,912,818 issued on Jun. 15, 1999, to R. Michael McGrady et al. describes a computer processing system for monitoring and dispensing medical items dispensed to patients including a reading device, a report generating device, and storage locations labeled to indicate an inventory status.

U.S. Pat. No. 5,832,449 issued on Nov. 3, 1998, to David W. Cunningham describes a system of dispensing, tracking and managing pharmaceutical product samples by linking prescribers and pharmacies to a central computer station.

U.S. Pat. No. 5,758,096 issued on May 26, 1998, to Howard Barsky et al. describes a computer based system for generating a medication management display by entering into a database a plurality of medication names prescribed for patients with corresponding strength attributes and alphanumeric medication symbol attributes. A patient medication chart is generated and adhesive graphic symbols are applied to the medication containers.

U.S. Pat. No. 5,666,492 issued on Sep. 9, 1997, to Keith D. Rhodes et al. describes a computer based pharmaceutical care cognitive services management system allows the transformation of a pharmacist from a vendor to a health care provider.

U.S. Pat. No. 5,301,105 issued on Apr. 5, 1994, to Desmond D. Cummings, Jr. describes a health care system which includes the integrated interaction of the patient, health care provider, bank or other financial institution, insurance company, utilization reviewer, and employer to provide the patients with complete health care.

U.S. Pat. No. 4,766,542 issued on Aug. 23, 1988, to Richard R. Pilarczyk describes a software system for pharmaceutical prescription compliance by contacting customers of a pharmacy automatically to remind them that their prescriptions need to be refilled.

The following patents describe various programming systems for ordering or billing customers.

U.S. Pat. No. 5,444,844 issued on Aug. 22, 1995, to Kimio Inoue et al. describes an automatic figure drawing apparatus (Computer Aided Drafting) and inventory purchasing system.

U.S. Pat. No. 5,870,717 issued on Feb. 9, 1999, to Charles F. Wiecha describes a system for ordering items over a computer network using an electronic catalogue.

U.S. Pat. No. 5,978,775 issued on Nov. 2, 1999, to Matthew S. C. Chen describes an information distribution system using a telephone network and the telephone company's billing service.

None of the above inventions and patents, taken either singly or in combination, is seen to describe the instant invention as claimed.

### SUMMARY OF THE INVENTION

The present invention is directed to a business method for collecting information about botanical, supplemental and homeopathic remedies as recommended or prescribed by a treating provider on behalf of a patient. The present invention electronically creates a unique code for these aforementioned products and an electronic connection to the universal product codes and the national drug codes.

Accordingly, it is a principal object of the invention to provide a business method for billing insurance carriers that originate from an overall treatment of a patient by an alternative practitioner or nurse.

It is another object of the invention to provide a business method creating unique codes for the prescribed, recommended or distributed botanical, supplemental and homeopathic remedies.

It is a further object of the invention to provide a business method creating electronic connections to the universal product codes of the botanical, supplemental and homeopathic remedies prescribed, recommended or distributed by a provider to the patient.

Still another object of the invention is to provide a business method creating electronic connections to the national drug codes of the prescribed, recommended or distributed botanical, supplemental and homeopathic remedies.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

The FIGURE is a block diagram of a billing process for botanical, supplemental and homeopathic remedies incorporating the universal product codes and the national drug codes according to the present invention.

### DETAILED DESCRIPTION OF THE PREFERRED EMBODIMENT

The present invention is directed to a method of doing business with healthcare providers ordering botanical, supplemental and homeopathic remedies. The sole FIGURE is a schematic block diagram of the business method employed in order to transact the billing process in accordance with electronic connections to the universal product codes and the national drug codes for verification.

Referring to the FIGURE, a computerized business method 10 based on a conventional computer system having a programmable memory and a central processing unit begins with the inputting and encoding of a patient encounter from the patient pool 12 with an alternative or nursing health care provider (AHCP) 14, wherein a provider is recommending or prescribing a botanical, supplemental or homeopathic product encoded in a database by alphanumeric indicia. The specialties are listed in the Table of the Giannini patent. The AHCP 14 provides a procedure claim 16 to the Alternative Coding System (ACS) 18 which encompasses a Provider Data (PD) database 20. The procedure claim 16 can be either in the form of a hard copy to be mailed or sent by remote electronic communications such as by the Internet.

The ACS 18 now processes the raw data in block 22 and communicates by an automated computer system to choose and retrieve information from the Alternative Practice Type (APT) control 24 and to match to the provider's procedure by accessing the Alternative Practice Type (APT) database 26. The data is transmitted to the block 28 which chooses and retrieves an Alternative Billing Code (ABC) from the ABC database 30 and compares the ABC with the APT for recommendation or prescriptive authority. The data from APT control 24 is also transmitted simultaneously to the block 32, wherein the process associated APT code is sent to the block 34 which processes the associated ABC code to combine with the transmission from block 28. The code is then transmitted to block 36 which also processes the Provider Data retrieved from the Provider Data database 20.

Returning to the information transmitted from block 28 to the Provider Data database 20, the block 38 now processes the provider's regional location information by its zip code and transmits to block 40 which processes the provider's specialty. Then the data is transmitted to block 42 wherein the ABC product codes and modifiers are connected to the Universal Product Code (UPC) 44 and/or to the National Drug Code (NDC) 46 for detailed product information. The data from UPC 44 and/or NDC 46 are electronically paired with the ABC product code 42 to convey more detailed information about the exact product specifications used in the patient encounter to calculate the cost 48. This combined information is transmitted to block 50 to generate Provider Data (PD) which is combined and processed with the ABC information received in block 36 outside the PD database 20. The processed PD information is then transmitted to block 52 which generates an Alternative Billing Code (ABC) by combining all of the ABC procedure codes and product codes used to treat the patient, and this information pairs with a diagnosis code (ICD-9CM or International Classification of Diseases, 9th Edition) from the claim form. This information is then sent to block 54 which is the CPT/ICD-9CM database (Current Procedural Terminology, 4th Edition, and compared with conventional ABC and treatments coded in the CPT table originating from the same ICD-9CM diagnosis. The compared information from block 54 is then transmitted to block 56, a communication center, which further sends the comparison table to the specific insurer or Third Party Administrator (insurer/TPA) in block 58. The insurer or TPA then has the tool to compare the charged cost from block 60 (premium payment) with the patient outcome from the visit to an alternative provider 14 to existing data for visits to conventional physicians. As a result, the insurer/TPA 58 pays the procedure claim payment 62 for the services to the alternative health care provider 14 when the cost and the patient outcome is favorable.

It is to be understood that the present invention is not limited to the sole embodiment described above, but encompasses any and all embodiments within the scope of the following claims.

I claim:

1. A method of doing business by encoding, documenting and processing the procedures of alternative healthcare provider treatment, using a computer system having a programmable memory and a central processing unit comprising the steps of:
programming a computer system having a programmable memory and a central processing unit for operating a business;
inputting and encoding a patient pool in the computer system;
inputting and encoding a procedure claim from an alternative health provider for treating a patient in the patient pool;
inputting and encoding a data base of a plurality of alternative healthcare providers to yield an alternative practice type (APT) code to identify the provider;
choosing and retrieving an APT from the APT data base and matching with the provider's procedure claim;
inputting and encoding a database of alternative billing codes (ABC) for each of the plurality of alternative healthcare provider categories to yield a standard alternative billing code (ABC) data base;
choosing and retrieving an ABC from the ABC data base and comparing to the APT for a diagnostic match with the performed procedure;
providing a provider data (PD) data base by regional location based on zip codes;
selecting a provider from the PD data base;
connecting the ABC product codes with a Universal Product Code (UPC) and a National Drug Code (NDC) for detailed information, and calculating the cost of the procedure;
generating a specific ABC cost and comparing with a diagnosis code to form a comparison table of costs for the procedure; and
sending the comparison table to an insurer or a third party administrator for payment to the alternative health care provider.

2. A programmed computer assembly for encoding, documenting and processing the procedures of alternative healthcare provider treatment comprising:
a computer having a programmable memory and a central processing unit;
a program installed on the computer having:
means for inputting and encoding a database of a plurality of alternative healthcare providers, wherein each is categorized by an alphanumeric indicia to yield an alternative practice type (APT) code database;
means for inputting and encoding a database of alternative billing codes (ABC) for each of the plurality of alternative healthcare providers by an alphanumeric indicia to yield a standard alternative billing code (ABC) database;
means for inputting and encoding a database of provider data (PD) comprising: (1) each provider's zip code; (2) each provider's specialty; (3) ABC product codes with any modifying information; (4) a universal product code (UPC) for each product and labeled with a UPC; (5) a national drug code (NDC) for each product labeled with a NDC; (6) calculating an average fee by provider specialty and region; and (7) generating specific provider data;
means for processing the associated APT code, the associated ABC code, and the generated the PD code;
means for generating an ABC from the associated APT code, the associated ABC code, and the generated PD code;
means for comparing the generated ABC string by diagnosis from the International Classification of Diseases' conventional procedural treatment strings to form a comparison table; and
means for publishing the comparison table for sending the comparison results to an alternative health care provider.
